(19) United States
(12) Patent Application Publication
(10) Pub. No.: US 2026/0302203 A1
(43) Pub. Date: Oct. 1, 2026

(54) METHODS FOR PREPARING LITHIUM TRANSITION METAL OXIDE FROM ELEMENTAL METAL FEEDSTOCKS AND PRODUCTS THEREOF

(71) Applicant: Dryve Battery Materials Inc., Dartmouth (CA)

(72) Inventors: Nutthaphon Phattharasupakun, Halifax (CA); Daniel Gawalewicz, Halifax (CA); Susi Jin, Kitchener (CA); Ryley Robert LeBlanc, Dartmouth (CA); Van At Nguyen, Dartmouth (CA); James Crighton, Halifax (CA); Will Craik, Halifax (CA); Erin Keltie, Lower Sackville (CA)

(21) Appl. No.: 18/996,353

(22) PCT Filed: Feb. 2, 2023
(86) PCT No.: PCT/US2023/061842

§ 371 Date: Jan. 17, 2025

Related U.S. Application Data
(60) Provisional application No. 63/373,036, filed on Aug. 19, 2022.

(51) Int. Cl. H01M 4/525; C01G 53/504; C01G 53/506

(52) U.S. Cl. CPC H01M 4/525; C01G 53/504; C01G 53/506; C01P 2002/54; C01P 2002/72; C01P 2002/85; C01P 2004/03; C01P 2006/40

(57) ABSTRACT

Disclosed herein is a method of preparing lithium transition metal oxide positive electrode materials from elemental feedstocks for secondary batteries and other applications and the product thereof. The methods disclosed herein may involve mixing of at least one transition metal in elemental form with lithium source in a dry solid-state mixing process followed by a sintering step to form the lithium transition metal oxide positive electrode materials.

### INCORPORATION BY REFERENCE TO ANY PRIORITY APPLICATIONS

This application is a 371 of International Application No. PCT/US2023/061842, which claims the priority benefit of U.S. Provisional Application No. 63/373,036, filed Aug. 19, 2022, the entire disclosure of which is incorporated herein by reference in its entirety.

### BACKGROUND OF THE INVENTION

### Field of the Invention

This disclosure relates to preparing lithium transition metal oxide positive electrode materials for lithium-ion batteries.

### Description of the Related Art

The development of high-energy storage systems, where lithium-ion (Li-ion) battery is the dominant technology, is the main driving force for the electrification of transportation. After years of exploring different chemistries to maximize energy storage output, recent studies have been focusing more on improving cycle life, and thermal safety of Li-ion battery cells. Also, with the growing demand for Li-ion battery cells, it is crucial to innovate the process of making battery materials at a lower cost and smaller environmental footprint.

A typical secondary Li-ion battery cell includes a graphite negative electrode, a lithium metal oxide positive electrode, a polymer separator, an organic electrolyte, and casings. Among them, the lithium metal oxide positive electrode material is a key component in deciding energy storage capability and battery cost. Among several types of lithium metal oxide materials, lithium nickel manganese cobalt oxide, known as “NMC”, is one of the most preferred cathode materials to be used in commercial battery cells.

The most common industrial route for preparing NMC includes multiple lengthy steps. The first step typically employs a co-precipitation process to make a mixed metal hydroxide precursor (MH), comprising essentially of the metals Ni, Mn, Co, and possibly dopant A. The molar ratio of elements is controlled at this step to achieve the desired composition. Usually, aqueous metal salts are precipitated in a NaOH solution in the presence of some chelating agent to obtain homogeneous elemental mixing. In later steps, a large amount of water is introduced for washing the as-synthesized metal hydroxide precipitate before drying in an oven at elevated temperature (typically, the production of 6.5 tonne/day NMC produces 99,000 L of wastewater that requires treatment and storage). This step alone consumes a lot of water and energy. The second step uses some mechanical mixing machines to mix metal hydroxide precursors with lithium compounds such as LiOH or Li₂CO₃. The third step is to calcine the above mixture in oxygen-containing atmospheres to form a lithiated metal oxide. The fourth step uses particle size classifiers to collect products in the desired size range. Sometimes, milling machines are used to break down agglomerates. The fifth step is the post-treatment or finishing step. In this step, products are washed, dried, and re-sintered at elevated temperatures. The washing might include a surface coating step, where the washing solution contains some chemicals that form protective coatings on the cathode surface after drying and refiring.

Atomic-scale mixing of transition metals (TM) could be achieved in MH precursors by using the well-known co-precipitation process. Good elemental mixing is crucial to achieve high-performance, single-phase NMC materials. However, the co-precipitation process results in a large quantity of wastewater that needs to be treated to meet environmental regulations. Moreover, soluble transition metal salts must be used as raw materials in the co-precipitation process. It is worth mentioning that insoluble transition metal compounds such as oxide, hydroxide, carbonate, or even transition metal powders are cheaper and readily available. Thus, alternative methods of producing NMC without using the co-precipitation process are important for the sustainable production of cathode materials.

Recently, several studies suggested some methods of making NMC and other positive electrode materials without using traditional methods.

WO2021040931A1 application describes a method for preparing lithium nickel manganese cobalt oxide (NMC) particulate using dry solid-state processes. Ni, Mn, and Co compounds selected from the group of oxide, hydroxide, and carbonate are mixed with Li sources (Li2O, LiOH, Li₂CO₃) by dry impact milling to form a precursor particulate prior to calcination. Ni, Mn, Co in metallic powder forms are not included as raw materials.

U.S. Pat. No. 8,591,860B2 application discloses a method for producing lithium metal oxide. A raw material mixture was made by mixing a lithium compound, an elemental Ni or Ni compound, other TM compounds, and a reaction accelerator made of one or more compounds selected from the group consisting of a carbonate, a sulfate, and a chloride of one or more elements selected from the group consisting of Na, K, Rb, Cs, Ca, Mg, Sr, and Ba. The reaction accelerator is required to improve reactivity during calcination, adjust surface area, and produce a stable lithium mixed metal oxide under a calcination atmosphere containing a higher concentration of CO₂ than that in the air. The calcining step is performed in a gas furnace using flame as a heat source. A mixture of combustion gas and oxygen was used to feed the gas furnace.

CN1326232A application disclosed a method for preparing lithium manganese oxide with spinel structure. The precursor was prepared by dissolving a mixture of Li salt and Mn source, from electrolytic manganese dioxide, chemical manganese dioxide, or high purity manganese metal, in an organic acid solution (acetic acid and/or etharedioic acid and/or oxalic acid and/or citric acid) using wet-high speed mixing method. After evaporating the above-mentioned precursor solution to form a gel precursor, it was then dried and calcined.

US20210359300A1 and US20220064019A1: The first application describes “a method of forming a lithium-ion metal oxide and a battery comprising the lithium-ion metal oxide. The method comprises reacting at least one metal in elemental form with carbox to form a metal carbox and heating the metal carbox to form said lithium-ion metal oxide.” The second application provides “a method for forming a lithium-ion cathode material. The method comprises reacting elemental metal with a multi-carboxylic acid to form an oxide precursor and heating the oxide precursor to form the lithium-ion cathode material. In a preferred embodiment, the elemental mixture comprises at least two of Ni, Mn, Co, and Al.” Both applications require the use of acid-based compounds, for example, oxalic acid, citric acid, carboxylic acid, nitric acid, etc. to form metal carbox complex with metal in elemental form. The lithium metal oxide precursor slurry is dried to remove solvent prior to sintering in a furnace to form a lithium-ion metal oxide having layered or spinel structures.

### SUMMARY OF THE INVENTION

Embodiments disclosed herein describe a method of preparing lithium transition metal oxide positive electrode materials from elemental metal feedstocks using a dry solid-state mixing approach. The mixed metals in elemental form and lithium source can be converted directly into lithium-transition metal precursor having a wide range of stoichiometric compositions. Further the sintering process on the said precursor can produce lithium transition metal oxide powder having a single phase without lithium impurities. Embodiments disclosed herein provide a more streamline, cost-effective, and environmentally friendly approach than the conventional wet method used in lithium transition metal oxide material manufacture.

In some embodiments, the method does not require the addition of any reaction accelerators or seeds in the mixing process. Raw metal feedstocks in elemental form and Li source are solely mixed followed by sintering at elevated temperature to form a single-phase lithium transition metal oxide material with well-ordered crystallinity.

Specifically, in some embodiments the method is used to form lithium transition metal oxide positive electrode material having an empirical formula Li₁₊ₓ[(NiₙMnₘCo_{c}Alₐ)_{1-y}A_{y}]₁₋ₓO₂ wherein −0.2≤x≤0.2; n+m+c+a=1; n≥0; m≥0; c≥0; a≥0; A is a metal dopant; and 0≤y≤0.05, the method comprising:
a) preparing a precursor mixture by combining a stoichiometric amount of one or more lithium compounds, one or more elemental or compounds of Ni, one or more elemental or compounds of Mn, one or more elemental or compounds of Co, one or more elemental or compounds of Al, and/or one or more elemental or compounds of a metal dopant according to the formula Li₁₋ₓ[(NiₙMnₘCo_{c}Alₐ)_{1-y}A_{y}]₁₋ₓO₂; wherein:
at least one transition metal is in the elemental form and is selected from the group consisting of Ni, Mn, and Co to form the said precursor;
compounds of the remaining metals are selected from the group consisting of oxides, hydroxides, oxyhydroxides, carbonates, sulfates, nitrates, acetates, and combinations thereof.
Li compound is selected from the group consisting of Li carbonate, Li oxide, Li hydroxide, Li acetate, Li chloride, Li fluoride, Li nitrate, Li sulfate, or mixtures thereof;
b) heating the said precursor to produce the lithium transition metal oxide positive electrode material having a single-phase structure.

In some embodiments, at least one metal in elemental form is mixed with other metal compounds, such as oxides, carbonates, sulfates, etc., and the lithium source. This creates a wide range of options for raw material selection depending on the cost, availability, and properties of each feedstock. Dopants selected from the group consisting of: Na, B, Al, Mg, Zr, Nb, Fe, Si, P, Mo, Ba, Sr, Ca, Zn, Cr, V, W, Nd, La, Cs, Ta, Ce, Cu, Eu, Ti, Sn, Sb, Pb, Bi, or Rb in elemental form or compounds can also be added in the mixing process to modify the lithium transition metal oxide properties.

The use of metal in elemental form may eliminate the need for suppliers to refine metal compounds streamlining the entire manufacturing process. The dry solid-state mixing also produces no wastewater and allows the use of class 2 non-soluble feedstocks, making the entire process more efficient.

During the lithiation step, the lithium source added into the mixing process can be LiOH, LiOH·H₂O, Li₂CO₃, Li₂O, and their mixtures wherein the amount of lithium added is within 20% of the stoichiometric formula Li₁₊ₓ[(NiₙMnₘCo_{c}Alₐ)_{1-y}A_{y}]₁₋ₓO₂. Optionally, lithium source can be added together with all transition metal feedstocks in a single step mixing process or added later after all transition metal feedstocks are mixed.

In the mixing process, dry solid-state mixing can be performed using mechanical mixing techniques, including but not limited to ball mill, bead mill, impact mill, autogrinder, high-speed mixer, trituration, acoustic mixer, mechanofusion, or blender, Depending on the particle size of feedstocks, impact milling or ball milling may be needed to further reduce the particle size and create a homogeneous mixing. For ball milling, choices and size of media can be varied based on permissible metal impurities, material hardness, and milling efficiency. Optionally, wet mixing using a small amount of water or ethanol (at least 90% fewer liquid byproducts than traditional processes) be performed to facilitate milling and material combination. Where a small amount of liquid is used, the ratio of sold:liquid is greater than 5:1, greater than 9:1, greater than 10:1, greater than 12:1, greater than 15:1, greater than 20:1 by weight. In a preferred embodiment the amount of liquid is sufficient to create a gel or slurry but is not enough to cause the solid to be suspended in the liquid.

The mixed lithium transition metal oxide precursor is calcined in a furnace under pure oxygen, inert gas, dry air, air, or their combination. Calcination can be done in a single-step heating protocol to maximum temperature or multiple steps with temperature holds in between. The calcination temperatures including temperature holds are in a range between 450-1000° C., wherein the total sintering time is in a range between 10-100 hours. Multiple-step heating is preferred in the case where raw material is dense or large and where Li source has low reactivity such as in the case of Li₂CO₃.

In some embodiments, post-modification such as re-heating is carried out to increase the crystallinity, lower cation mixing, reduce lithium residuals, smoothen the surface of the lithium transition metal oxide product or combinations thereof. Re-heating can be performed under pure oxygen, inert gas, dry air, air, or their combination at a temperature greater than 500° C. for greater than 1 hour. The choice of atmospheres depends on the moisture sensitivity, amount of impurities, and stoichiometric composition of the lithium transition metal oxide product.

The calcined lithium transition metal oxide may contain some particle agglomerations which can be pulverized by impact mill, jet mill, or grinder. In at least one embodiment, deagglomeration is performed to increase homogeneity of particle, create unimodal particle size distribution, and reduce grain boundaries between particles. This can increase electrode packing efficiency and reduce possibility of cell failure generally arising from cracks between grain boundaries of particles.

The lithium transition metal oxide product can be prepared with a single-phase structure having high crystallinity using elemental metal feedstocks. The well-developed crystal structure is indicated by the percentage of cation mixing; the amount of Ni in the Li layers, which is below 6%. As the material having low cation mixing can be less prone to phase transformation and cracking during cycling. The low cation mixing is advantageous for rate capability and cycling stability when the material is assembled into a battery cell.

The lithium transition metal oxide product can be used as positive electrode material for secondary batteries in a wide range of commercial applications. Different stoichiometric compositions bring about different energy density, safety features, and cycling stability suitable for use in various applications. The conversion of elemental metal feedstocks to lithium transition metal oxide product disclosed in embodiments herein is a dry and streamline process alternative to the complicated wet method used in the positive electrode material manufacturing industry.

### BRIEF DESCRIPTION OF THE DRAWINGS

FIG. 1 shows SEM images of N6-1, N6-2, N6-3, and N6-4 materials of Example 1.

FIG. 2 shows the XRD patterns of N6-1, N6-2, N6-3, and N6-4 materials of Example 1.

FIG. 3a shows the first cycle charge-discharge profile at C/20 of coin-cell made with N6-3 material.

FIG. 3b show the capacity retention of coin-cell made with N6-3 material.

FIG. 4 shows the XRD patterns of N6-5 and N6-6 materials of Example 2.

FIG. 5 shows SEM images of N8-1 and N8-2 materials of Example 3.

FIG. 6 shows the XRD patterns of N8-1 and N8-2 materials of Example 3.

FIG. 7a shows the first cycle charge-discharge profile at C/20 of coin-cell made with N8-1 material.

FIG. 7b shows the first cycle charge-discharge profile at C/20 of coin-cell made with N8-2 material.

FIG. 7c shows the capacity retention of coin-cell made with N8-1 material.

FIG. 7d shows the capacity retention of coin-cell made with N8-2 material.

FIGS. 8a and 8b show SEM images of N8-3 material at different magnifications of Example 4.

FIG. 8c shows EDX elemental mapping of Ni of N8-3 material.

FIG. 8d shows EDX elemental mapping of Co of N8-3 material.

FIG. 8e shows EDX elemental mapping of Mn of N8-3 material.

FIG. 8f shows EDX elemental mapping of Al of N8-3 material.

FIG. 9 shows the XRD patterns of N8-3 material of Example 4.

FIGS. 10a and 10b show SEM images of N8-4 material at different magnifications of Example 5.

FIG. 10c shows EDX elemental mapping of Ni of N8-4 material.

FIG. 10d shows EDX elemental mapping of Co of N8-4 material.

FIG. 10e shows EDX elemental mapping of Mn of N8-4 material.

FIG. 11 shows the XRD patterns of N8-4 material of Example 5.

### DETAILED DESCRIPTION OF THE PREFERRED EMBODIMENT

Embodiments of the present disclosure may relate to the production of lithium transition metal oxide electrode materials and the product thereof. In a preferred embodiment the process is a dry or substantially dry processes. The process may allow for the production of lithium transition metal oxide electrode materials with minimal or no solvent or wastewater byproducts.

The production of a lithium transition metal oxide electrode material may proceed through the mixing of a precursor mixture in the absence of a solvent followed by the heating of the precursor mixture. The precursor mixture may be a combination containing at least two of lithium, nickel, manganese, cobalt, aluminum, and a dopant. The mixed and heated precursor mixture generally results in a lithium transition metal oxide electrode material with the formula Li₁₊ₓ[(NiₙMnₘCo_{c}Alₐ)_{1-y}A_{y}]₁₋ₓO₂, wherein: −0.2≤x≤0.2; n+m+c+a=1; n≥0; m≥0; c≥0; a≥0; A is a metal dopant; and 0≤y≤0.05. Dopants of the precursor mixture may be selected from Na, B, Al, Mg, Zr, Nb, Fe, Si, P, Mo, Ba, Sr, Ca, Zn, Cr, V, W, Nd, La, Cs, Ta, Ce, Cu, Eu, Ti, Sn, Sb, Pb, Bi, Rb, or mixtures thereof.

In any of the embodiments disclosed herein the metals used may be elemental metals. In at least one embodiment the transition metals of Ni, Mn, Co, and Al are provided in elemental form. In at least one embodiment all of the transition metals are provided in elemental form. The elemental form of the metals may comprise metals that are comprised of a single chemical element or oxide thereof. The elemental form may exclude cationic/anionic salts of the metal compounds, or compounds containing metals that are in an oxidized state. In embodiment disclosed herein the element form of the metal may be substantially free of other chemical elements.

The elemental form of the metals may comprise raw elemental metal. In embodiments herein the elemental metal may be sufficiently pure or substantially pure metal. The purity of the metal may be at least 50% pure, at least 60% pure, at least 70% pure, at least 80% pure, at least 90% pure, at least 95% pure, or at least 99% pure. The metals may be provided in a sufficiently pure form, such as class 2 feedstocks. The metals may be provided as non-soluble feedstocks.

In any embodiments disclosed herein the precursor mixture may be heated with or without holds and with or without post-modification or re-heating. The heat treatment of the precursor mixture may be employed to oxidize the precursor mixture and produce the structure of a lithium transition metal oxide electrode material. The heating of the precursor mixture may be a high temperature sintering step. The sintering step may be done in the presence of oxygen. Alternatively, the sintering step may be performed under an inert atmosphere, oxygen, a reduced oxygen partial pressure gas, dry air, or air. The inert atmosphere may be composed of an inert gas such as helium, argon, neon, or in the presence of nitrogen gas (N₂). The sintering of the lithium precursor may be performed in a substantially water-free environment. The sintering temperature may be elevated beyond the melting temperature of at least one metal in the precursor solution. For example, the sintering may be performed in excess of the melting point of lithium or aluminum. The sintering temperature in any of the embodiments herein may be greater than 500 degrees Celsius, greater than 550 degrees Celsius, greater than 600 degrees Celsius, greater than 650 degrees Celsius, greater than 700 degrees Celsius, greater than 750 degrees Celsius, greater than 800 degrees Celsius, greater than 900 degrees Celsius, or greater than 1000 degrees Celsius. The post-modification reheating temperature may likewise be in the temperature ranges disclosed above, in excess of 500 degrees Celsius. The heating of the precursor may be in the range of about 1-150 hours, about 5-120 hours, about 10-100 hours, or at least 5 hours.

In any of the embodiments disclosed herein the mixing of the precursor solution may be performed in the absence of a solvent. The mixing may be performed in the absence of water, resulting in a mixing process that excludes the production of wastewater as a byproduct. In any embodiment disclosed herein the substantially free water environment may be substantially free of liquid water or a liquid solvent. The liquid solvent may be a polar solvent or a non-polar solvent, such as an organic solvent. In embodiments herein the process may also exclude the use of an acidic or basic solution.

The dry mixing may be performed according to any dry mixing process known in the art as long as the precursor solution may be mixed in the absence of a liquid solvent. Examples of suitable dry mixing techniques may be ball milling, autogrinding, impact milling, high-speed mixing, trituration, acoustic mixing, mechanofusion, or blending. The mixing may be performed or combined with a fluidiziation or pneumatic process. The mixing may also be performed at an elevated temperature.

Various procedures of the process disclosed in embodiments herein may be combined together or separated into two distinct steps. For example, the addition of lithium to the precursor solution or the transition metals and/or dopant may be performed in a single lithiation operation, or the addition of lithium may be performed stepwise in two mixing steps. The lithium may also be added in excess of the other metals in the precursor solution. The lithium may be in excess of the other elements, according to stoichiometric ratios, by less than 40%, less than 30%, less than 20%, less than 15%, less than 10%, less than 5%, or less than 1%.

The stoichiometric ratios disclosed in any of the embodiments herein may be ratios that are not whole integers. For example, in at least one embodiment the lithium transition metal oxide electrode material produced under this disclosure may be described according to the formula LiNi_{0.6}Mn_{0.2}Co_{0.2}O₂, LiNi_{0.83}Mn_{0.06}Co_{0.11}O₂, or LiNi_{0.8}Mn_{0.1}Co_{0.1}O₂, where the proportion of Li to Ni to Mn to Co to O₂ is not described by whole integers but by fractions or decimals. In certain circumstances the subscripts of the formula may be multiplied by a value in order to obtain whole integer subscripts, but the stoichiometric proportions of chemical elements in the lithium transition metal oxide electrode material would remain the same.

The lithium transition metal oxide electrode material in any of the embodiments disclose herein may be incorporated into a battery. The battery may be a lithium ion battery, and the lithium transition metal oxide electrode material may be incorporated as an active material in the cathode of the battery. The battery may contain additional components such as a liquid or solid electrolyte, a membrane, an anode active material, current collectors and supporting additives such as binders and conductivity enhancers for the anode and cathode materials, and structural features such as a battery casing. The battery may be a lithium ion battery. The battery anode active material may be optimized with the lithium transition metal oxide electrode material in any of the embodiments disclosed herein to produce the highest electrochemical cell potential. The components of the battery may be substantially pure and optimized to reduce side reactions, such as chemical dendrites, during the charging and discharging of the electrochemical cell.

The lithium transition metal oxide electrode material disclosed in any of the embodiments herein may be incorporated as the active material in the cathode of the battery. The lithium transition metal oxide electrode material may be incorporated via dry or wet processes. For example, the lithium transition metal oxide electrode material may be applied to the current collector via a binder with or without compression during the application.

The lithium transition metal oxide electrode material disclosed in embodiments herein may be a single phase layered O3 phase. The O3 single phase O3 structure may be free of Li impurities. An O3 structure is beneficial in that it possesses high conductivity, which is a critical property for cathode materials. Conductivity is a measure of how well a material can conduct electricity, and high conductivity is important in cathodes because it allows electrons to flow easily through the material, enabling efficient charge transfer. O3 structures are also known for structural stability, which makes it resistant to damage from external factors such as heat and stress. This stability allows cathode materials with an O3 structure to maintain their performance over a long period of time, even in demanding applications.

The methods and products described in the embodiments herein are superior to traditional methods of the prior art. Embodiments described herein provide methods for the production of a lithium transition metal oxide electrode material without a solvent, reducing negative environmental impacts of excessive wastewater and soluble byproducts. Additionally, the materials provided in the precursor mixture may be produced from cost-efficient materials, such as elemental metals, metal compounds, and lithium salts, such as Li carbonate, Li oxide, Li hydroxide, Li acetate, Li chloride, Li fluoride, Li nitrate, Li sulfate. The wide variety of precursor materials, such as elemental materials or chemical salts and compounds, that may be provided in the precursor mixture enables a more streamlined, environmentally friendly, and cost-effective approach for the production of lithium transition metal oxide electrode materials.

### Examples

The following are exemplary in nature to better illustrate the present invention and are non-limiting in scope, application or uses.

### Material Characterization

Scanning electron microscope (SEM) images and Energy-dispersive X-ray spectroscopy (EDX) mapping images were taken using a Phenom XL G2 Desktop SEM with an accelerating voltage of 15 kV under a back scattering electron mode. Powder samples were prepared by adhering onto a sample stub using conductive carbon tape.

X-ray diffraction (XRD) patterns of powders were measured by a Bruker D8 Advance diffractometer with a Cu Kα X-ray source and a diffracted beam monochromator. Rietveld refinement was done on the measured XRD patterns to quantify the amount of cation mixing: Ni in the Li layers using Rietica software.

### Cell Preparation and Electrochemical Evaluation

Electrode slurries were prepared by mixing of active material, carbon black (Imerys/Timcal SuperP), and polyvinylidene fluoride (PVDF, Solvay Solef 5130) in a weight ratio of 0.94:0.04:0.02 in N-Methyl-2-Pyrrolidone (NMP, Fisher Scientific, 99.9%) with a solid content of 50% using a planetary mixer. The slurry was coated onto 15 μm aluminum foil sheet using the doctor blade method and dried on a 90° C. drying table in air before final drying in a vacuum ovenat 100-120° C. overnight. The dried electrodes were compressed using by calendar rolling and punched with a 13.00 mm diameter. The areal active mass loading was ~18-22 mg/cm². Coin-cells were fabricated in an Ar filled glovebox with one sheet of active electrode, Li foil counter electrode, 2 layers of separator (Celgard 2500), and 100 μL of 1.2M LiPF₆ in a solution of ethylene carbonate:ethylmethyl carbonate:dimethyl carbonate (EC:EMC:DMC (25:5:70 wt %), CapChem) electrolyte using CR2032 coin-type casings. Galvanostatic cycling measurements were made using a NOVONIX ultra high-precision coulometry system at a controlled temperature of 25° C.
Example 1. NMC622 made from all elemental metals using high-speed mixer.

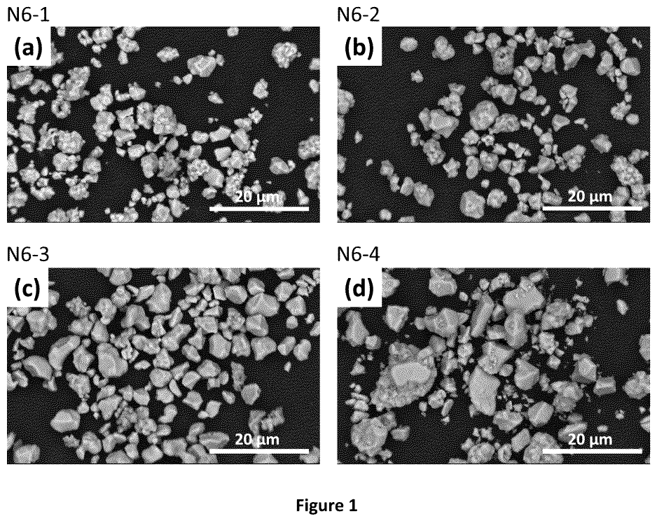

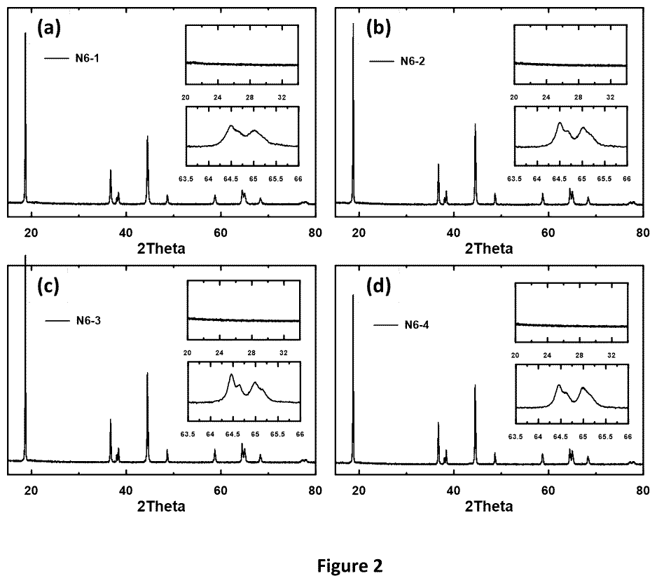

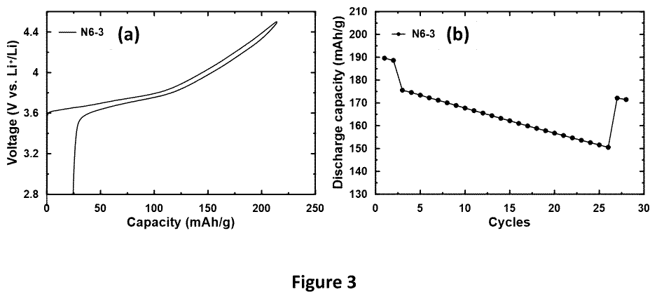

This example of LiNi_{0.6}Mn_{0.2}Co_{0.2}O₂ (NMC622) was made by mixing of Ni powder, Mn powder, Co powder, and 5% excess Li₂CO₃ in a stochiometric ratio of LiNi_{0.6}Mn_{0.2}Co_{0.2}O₂ in a high-speed conical mixer (Xinguang, VCH-30L) for 1.5 h at 750 rpm. The mixed powder was then transferred into an alumina crucible and heated in a tube furnace at different sintering temperatures and atmospheres for 20 h. Table 1 shows the list of samples heated at 920° C. in O₂ (N6-1), 940° C. in O₂ (N6-2), 960° C. in O₂ (N6-3), and 940° C. in air (N6-4). All samples were heated at 600° C. for 3 h before reaching a final sintering temperature which was held for 20 h then cooled down to room temperature. Heating and cooling rates of 10° C./min and 1° C./min were used, respectively. FIG. 1 shows that all samples have a single crystal morphology with a smooth surface. Materials became less agglomerated with increasing sintering temperatures. Samples made in air (FIG. 1d) showed slightly larger particle sizes and more particle agglomeration. FIG. 2 shows the XRD patterns of all samples having a pure single phase layered O3 phase without Li impurities. A clear peak separation between (108)/(110) at 65° can be observed in all samples indicating a very high degree of and well-ordered crystallinity. The cation mixing varied between 2.5-5.0% as listed in Table 1. FIG. 3 shows an example of electrochemical performances of N6-3 material. FIG. 3a shows the first cycle charge-discharge profile tested between 2.8-4.5 V vs. Li⁺/Li at C/20. A reversible discharge capacity of 189.5 mAh/g can be obtained with an irreversible capacity of 11.42%. FIG. 3b shows galvanostatic cycling of the N6-3 half-cell tested at C/20 formation for 2 cycles, followed by C/5 for 25 cycles, and C/20 check-up for 2 cycles. The C/5 capacity retention was ~85.5% after 25 number of cycles.

TABLE 1

| Sample | Temperature (° C.) | Time (h) | Atmosphere | % Ni/Li |
|---|---|---|---|---|
| N6-1 | 920 | 20 | Oxygen | 5.02 |
| N6-2 | 940 | 20 | Oxygen | 4.26 |
| N6-3 | 960 | 20 | Oxygen | 2.50 |
| N6-4 | 940 | 20 | air | 2.65 |

Example 2. Post-modification of NMC622 made from all elemental metals using autogrinder.

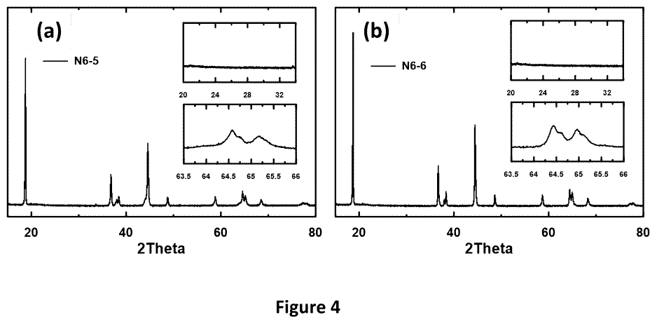

In this example, NMC622 was made by mixing of Ni powder, Mn powder, Co powder, and 5% excess LiOH·H₂O in a stochiometric ratio of LiNi_{0.6}Mn_{0.2}Co_{0.2}O₂ in an autogrinder for 20 min to form a homogeneous mixture. The mixed powder was then transferred into an alumina crucible and heated in a tube furnace at 600° C. for 3 h then 940° C. for 20 h in O₂ to form N6-5. Sample N6-5 was taken out of the tube furnace after cooling to room temperature and hand ground using a mortar and pestle. The sample was heated in a tube furnace for post-modification and to 940° C. for 12 h in O₂ then cooled to room temperature to form N6-6. The heating rate was 10° C./min and the cooling rate was 1° C./min for both samples. The sintering condition is listed in Table 2. FIG. 4a shows the XRD of N6-5 after the first step heating. Peak broadening apart from O3 layered phase can be observed as well as a Li impurity peak at ~33° indicating that the material was not a pure phase and the lithiation reaction was incomplete. FIG. 4b shows the XRD of sample N6-6 after reheating at 940° C. for 12 h. The intensities of the (003) plane at 18° and the (104) plane at 43° significantly increased and the (108)/(110) planes at ~65° were clearly separated without peak broadening indicating that the N6-6 material became pure layered phase. The cation mixing of N6-6 material was 4.16% similar to the N6-2 material made at the same sintering temperature with Li₂CO₃.

TABLE 2

| | | 1^{st} | 2^{nd} | | |
|---|---|---|---|---|---|
| | | step | step | Atmo- | |
| Sample | % LiOH•H2O | heating | heating | sphere | % Ni/Li |
| N6-5 | 5% excess | 940 C. 20 h | — | Oxygen | — |
| N6-6 | 5% excess | 940 C. 20 h | 940 C. 12 h | Oxygen | 4.16 |

Example 3. NMC811 made from all elemental metals using autogrinder.

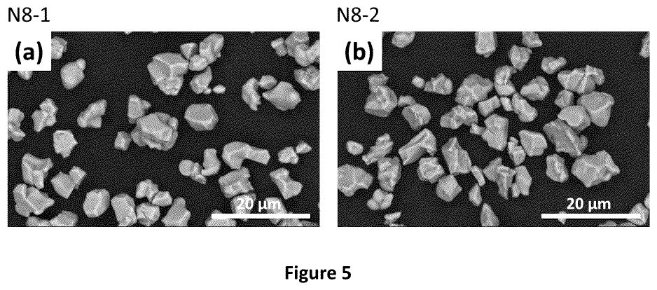

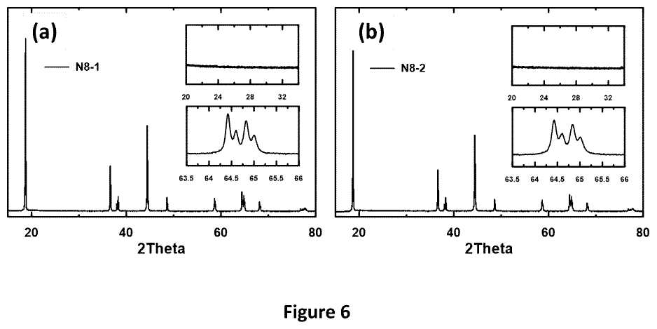

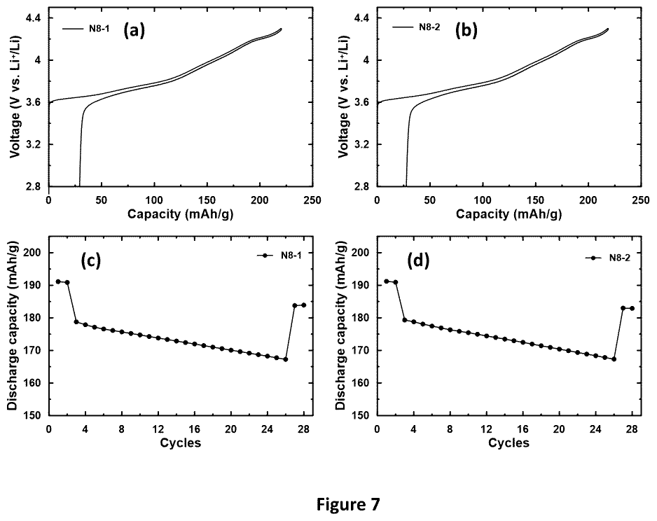

In this example, NMC811 was made by mixing Ni powder, Mn powder, Co powder, and Li₂CO₃ in a stochiometric ratio of LiNi_{0.8}Mn_{0.1}Co_{0.1}O₂ in an autogrinder for 20 min to form a homogeneous mixture. 1% excess Li₂CO₃ was used to form N8-1 sample and 5% excess Li₂CO₃ was used to form N8-2 sample as listed in Table 3. The mixed powder was transferred into an alumina crucible and sequentially heated in a tube furnace at 600° C. for 3 h, 920° C. for 20 h, and 870° C. for 5 h then cooled down to room temperature under O₂ atmosphere. The heating and cooling rates were 10° C./min and 1° C./min, respectively. FIG. 5 shows the SEM images of N8-1 and N8-2, indicating that the synthesized powders have single crystal morphology with smooth surfaces and clear facets. FIG. 6 shows the XRD patterns of N8-1 and N8-2 materials. Both samples showed a well-developed layered structure with clear (108)/(110) peak separation indicating of a very high crystallinity. No lithium impurities were observed. Both N8-1 and N8-2 materials showed a very small amount of cation mixing which were 1.29% and 1.81%, respectively. FIGS. 7a and b show the first cycle charge-discharge profiles tested between 2.8-4.3 V vs. Li/Li⁺ at C/20 of N8-1 and N8-2 materials. A high reversible discharge capacity of 191.1 mAh/g and 190.5 mAh/g and an irreversible capacity of 13.36% and 12.76% can be obtained for N8-1 and N8-2, respectively. Both samples also showed a very small overpotential during initial charge and small voltage hysteresis indicating low material impedance. FIGS. 7c and d show galvanostatic cycling of N8-1 and N8-2 half-cells tested at C/20 formation for 2 cycles, followed by C/5 for 25 cycles, and C/20 check-up for 2 cycles. The C/5 capacity retention were 93.56% and 93.90% after 25 number of cycles, respectively.

TABLE 3

| | | Temperature | | | |
|---|---|---|---|---|---|
| Sample | % Li₂CO₃ | (° C.) | Time (h) | Atmosphere | % Ni/Li |
| N8-1 | 1% excess | 920 | 20 | Oxygen | 1.29 |
| N8-2 | 5% excess | 920 | 20 | Oxygen | 1.81 |

Example 4. NMCA made from Ni, Co, and Mn elemental metals and Al₂O₃ using autogrinder.

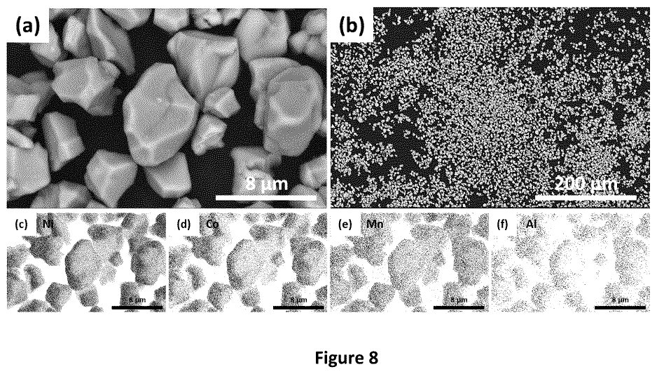

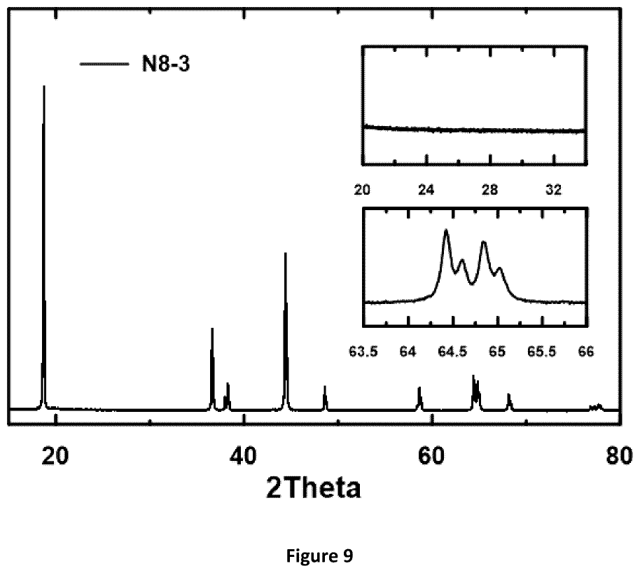

The NMCA powder was synthesized by mixing of Ni powder, Mn powder, Co powder, Al₂O₃ powder, and 1% excess Li₂CO₃ in a stochiometric ratio of Li(Ni_{0.8}Mn_{0.1}Co_{0.1})_{0.99}Al_{0.01}O₂ in an autogrinder for 20 min to form a homogeneous mixture. The mixed powder was transferred into an alumina crucible and sequentially heated in a tube furnace at 600° C. for 3 h, 920° C. for 20 h, and 870° C. for 5 h then cooled to room temperature under O₂ atmosphere to form N8-3. FIGS. 8a and b show the SEM images of N8-3 material at different magnifications. A uniform single crystal morphology was observed without agglomeration. The material has a smooth surface and well-defined facets. FIG. 8c-f show EDX elemental mapping images of Ni, Co, Mn, and Al, respectively. All elements showed homogeneous elemental distribution in all particles, even with only 1 mol % Al. This confirms the successful synthesis and lithiation of Ni-rich cathode made from elemental metal raw materials. FIG. 9 showed the XRD patterns of N8-3 material having a pure single layered O3 phase without Li impurities. A clear peak separation between (108)/(110) at 65° can be observed indicating of a very high and well-ordered crystallinity. The cation mixing calculated from Rietveld refinement was 1.61%.
Example 5. NMC811 made from elemental metals mixed with metal compound (NiO+Mn+Co).

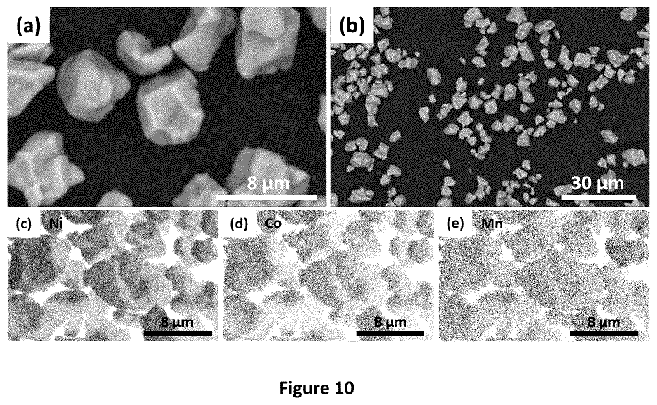

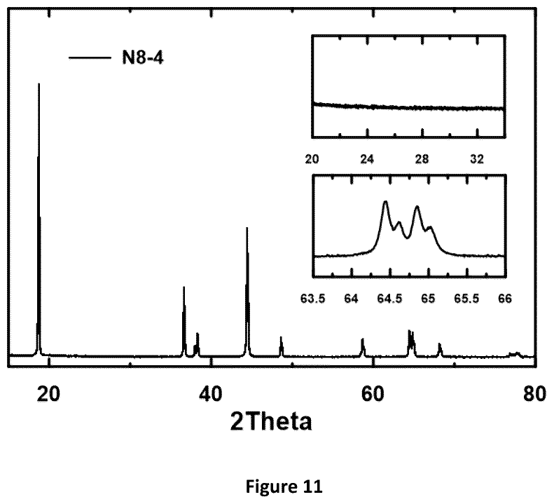

In this example, NMC811 was made by mixing of NiO powder, Mn powder, Co powder, and 1% excess Li₂CO₃ in a stochiometric ratio of LiNi_{0.8}Mn_{0.1}Co_{0.1}O₂ in an autogrinder for 20 min to form a homogeneous mixture. The mixed powder was transferred into an alumina crucible and sequentially heated in a tube furnace at 600° C. for 3 h, 920° C. for 20 h, and 870° C. for 5 h then cooled down to room temperature under O₂ atmosphere to form N8-4. FIGS. 10a and b show the SEM images of N8-4 material at different magnifications. A uniform single crystal morphology was observed without agglomeration or incomplete lithiated particles. The cathode powder exhibited a smooth surface and well-defined facets. FIG. 10c-e show EDX elemental mapping images of Ni, Co, and Mn, respectively. All elements were homogeneously distributed throughout the particles. FIG. 11 showed the XRD patterns of N8-4 material having a pure single layered O3 phase without Li impurities. A clear peak separation between (108)/(110) at 65° can be observed indicating of a very high and well-ordered crystallinity. The cation mixing calculated from Rietveld refinement was 1.75%.

### Alternatives

Accordingly, some aspects described herein relate to the following numbered alternatives:
Alternative 1. A method of preparing a lithium transition metal oxide positive electrode material for a secondary battery having the empirical formula (1) Li₁₊ₓ[(NiₙMnₘCo_{c}Alₐ)_{1-y}A_{y}]₁₋ₓO₂, wherein:

$$- 0.2 \leq x \leq 0.2 ;$$

$$n + m + c + a = 1 ;$$

$$n \geq 0 ; m \geq 0 ; c \geq 0 ; a \underline{>} 0 ;$$

A is a metal dopant;

$$0 \leq y \leq 0.05 ;$$

the method comprising:
(A) preparing a precursor mixture by combining together a stoichiometric amount of one or more lithium compounds, according to the formula (1) wherein:
at least one transition metal is in the elemental form and is selected from the group consisting of Ni, Mn, and Co to form the precursor mixture;
compounds of the remaining metals are selected from the group consisting of oxides, hydroxides, oxyhydroxides, carbonates, sulfates, nitrates, acetates, and combinations thereof;
the one or more Li compounds is selected from the group consisting of Li carbonate, Li oxide, Li hydroxide, Li acetate, Li chloride, Li fluoride, Li nitrate, Li sulfate, and mixtures thereof; and
(B) heating the precursor mixture to produce the lithium transition metal oxide positive electrode material.
Alternative 2. The method of alternative 1, wherein the lithium transition metal oxide positive electrode material has a single-phase structure.
Alternative 3. The method of Alternative 1 or any of the preceding alternatives, wherein the lithium transition metal oxide positive electrode material is a single-phase crystalline structure.
Alternative 4. The method of Alternative 1 or any of the preceding alternatives, wherein the lithium transition metal oxide positive electrode material is a single-phase structure free of lithium impurities.
Alternative 5. The method of Alternative 1 or any of the preceding alternatives, wherein the preparation of precursor mixture step is done by dry mixing using a ball mill, autogrinder, impact mill, high-speed mixer, trituration, acoustic mixer, mechanofusion, or blender or wet mixing using a wet mill or a combination thereof.
Alternative 6. The method of Alternative 1 or any of the preceding alternatives, wherein the preparation of precursor mixture step is done in two steps in which the first mixing step is done without the one or more Li compounds and the one or more Li compounds is added in the second mixing step.
Alternative 7. The method of Alternative 1 or any of the preceding alternatives, wherein the transition metals of the at least one transition metal in the precursor mixture are in elemental form.
Alternative 8. The method of Alternative 1 or any of the preceding alternatives, wherein A is selected from the group consisting of: Na, B, Al, Mg, Zr, Nb, Fe, Si, P, Mo, Ba, Sr, Ca, Zn, Cr, V, W, Nd, La, Cs, Ta, Ce, Cu, Eu, Ti, Sn, Sb, Pb, Bi, Rb, and mixtures thereof.
Alternative 9. The method of Alternative 1 or any of the preceding alternatives, where the preparation of precursor mixture uses feedstock wherein: the compounds of Ni contain no metal element other than Ni; the compounds of Mn contain no metal element other than Mn; the compounds of Co contain no other metal element other than Co; the compounds of Al contain no other metal element other than Al;
Alternative 10. The method of Alternative 1 or any of the preceding alternatives, wherein y is zero.
Alternative 11. The method of Alternative 1 or any of the preceding alternatives, wherein n is zero.
Alternative 12. The method of Alternative 1 or any of the preceding alternatives, wherein m is zero.
Alternative 13. The method of Alternative 1 or any of the preceding alternatives, wherein c is zero.
Alternative 14. The method of Alternative 1 or any of the preceding alternatives, wherein a is zero.
Alternative 15. The method of Alternative 1 or any of the preceding alternatives, wherein y is not zero and at least one of n, m, c, a is zero.
Alternative 16. The method of Alternative 1 or any of the preceding alternatives, wherein said lithium transition metal oxide is LiNi_{0.6}Mn_{0.2}Co_{0.2}O₂ or LiNi_{0.83}Mn_{0.06}Co_{0.11}O₂.
Alternative 17. The method of Alternative 1 or any of the preceding alternatives, wherein said lithium transition metal oxide is LiNi_{0.8}Mn_{0.1}Co_{0.1}O₂.
Alternative 18. The method of Alternative 1 or any of the preceding alternatives, wherein heating the precursor mixture is carried out under an atmosphere of inert gas, oxygen, a reduced oxygen partial pressure gas, dry air, or air.
Alternative 19. The method of Alternative 1 or any of the preceding alternatives, wherein the heating temperature is in a range between about 450-1000° C. carried out with one or multiple temperature holds.
Alternative 20. The method of Alternative 1 or any of the preceding alternatives, wherein the heating temperature is in a range between about 700-1000° C. carried out with one or multiple temperature holds.
Alternative 21. The method of Alternative 1 or any of the preceding alternatives, wherein the heating temperature is in a range between about 450-750° C. carried out with one or multiple temperature holds.
Alternative 22. The method of Alternative 1 or of any of the preceding alternatives, wherein the total heating time is in a range between about 10-100 hours.
23. The method of Alternative 1 or of any of the preceding alternatives, wherein the total heating time is in a range between about 50-100 hours.
Alternative 24. The method of Alternative 1 or any of the preceding alternatives, wherein the lithium compound is added in excess of the stoichiometric amount not greater than 20%.
Alternative 25. The method of Alternative 1 or any of the preceding alternatives, wherein lithiation is done in one step.
Alternative 26. The method of Alternative 1 or any of the preceding alternatives, wherein lithiation is done in two steps where a first lithiation step is carried out with −0.2≤x<0 and a second lithiation step is carried out with the remaining stoichiometric quantity of Li where a total x≤0.20.
Alternative 27. The method of Alternative 1 or any of the preceding alternatives, wherein lithiation is done in two steps where a first lithiation step is carried out with −0.1≤x<0 and a second lithiation step is carried out with the remaining stoichiometric quantity of Li where a total x≤0.10.
Alternative 28. The method of Alternative 1 or any of the preceding alternatives, wherein post-modification is done on the lithium transition metal oxide by additionally re-heating under an atmosphere of inert gas, oxygen, a reduced oxygen partial pressure gas, dry air, and air.
Alternative 29. The method of Alternative 1 or any of the preceding alternatives, wherein the reheating temperature is greater than 500° C. for greater than 1 hour.
Alternative 30. The method of Alternative 1 or any of the preceding alternatives, wherein the percentage of cation mixing, the amount of Ni in the Li layers, in the lithium transition metal oxide product is lower than 6.0 mol %.
Alternative 31. The method of Alternative 1 or any of the preceding alternatives, wherein the combining of the precursor mixture comprises mixing the precursor mixture in the absence of a solvent.
Alternative 32. The method of Alternative 1 or any of the preceding alternatives, wherein the combining of the precursor mixture comprises mixing the precursor mixture in a substantially water-free environment.
Alternative 33. The method of Alternative 1 or any of the preceding alternatives, wherein the precursor mixture is mixed in a wet process where the ratio of solid:liquid is at least 5:1 by weight.
Alternative 34. The method of Alternative 1 or any of the preceding alternatives, wherein the method is performed without the addition of any reaction accelerators or seeds in the mixing process.
Alternative 35. The method of Alternative 1 or any of the preceding alternatives, wherein the precursor mixture is mixed in the absence of a slurry.
Alternative 36(a). The method of Alternative 1 or any of the preceding alternatives, wherein the precursor mixture is mixed in the absence of an organic solvent.
Alternative 36(b). The method of Alternative 1 or any of the preceding alternatives, wherein the precursor mixture is mixed in the absence of a protic solvent.
Alternative 37. The method of Alternative 1 or any of the preceding alternatives, wherein the precursor mixture is mixed in the absence of a polar solvent.
Alternative 38. The method of Alternative 1 or any of the preceding alternatives, wherein the precursor mixture is mixed in the absence of a non-polar solvent.
Alternative 39. The method of Alternative 1 or any of the preceding alternatives, wherein the precursor mixture is mixed in the absence of an acidic or basic solution.
Alternative 40. The method of Alternative 1 or any of the preceding alternatives, wherein the precursor mixture is mixed in a solid state free of solvent residue.
Alternative 41. The method of Alternative 1 or any of the preceding alternatives, wherein a mixing step and a heating step are performed in tandem.
Alternative 42. The method of Alternative 1 or any of the preceding alternatives, wherein: −0.19≤x≤0.19.
Alternative 43. The method of Alternative 1 or any of the preceding alternatives, wherein: −0.18≤x≤0.18.
Alternative 44. The method of Alternative 1 or any of the preceding alternatives, wherein: −0.15≤x≤0.15.
Alternative 45. The method of Alternative 1 or any of the preceding alternatives, wherein: −0.12≤x≤0.12.
Alternative 46. The method of Alternative 1 or any of the preceding alternatives, wherein: −0.1≤x≤0.1.
Alternative 47. The method of Alternative 1 or any of the preceding alternatives, wherein: x=0.
Alternative 48. The method of Alternative 1 or any of the preceding alternatives, wherein: 0≤y≤0.04.
Alternative 49. The method of Alternative 1 or any of the preceding alternatives, wherein: 0≤y≤0.03.
Alternative 50. The method of Alternative 1 or any of the preceding alternatives, wherein: 0≤y≤0.02.
Alternative 51. The method of Alternative 1 or any of the preceding alternatives, wherein: 0≤y≤0.01.
Alternative 52. The method of Alternative 1 or any of the preceding alternatives, wherein: 0≤y≤0.001.
Alternative 53. The method of Alternative 1 or any of the preceding alternatives, wherein Ni is provided in the elemental form.
Alternative 54. The method of Alternative 1 or any of the preceding alternatives, wherein Mn is provided in the elemental form.
Alternative 55. The method of Alternative 1 or any of the preceding alternatives, wherein Co is provided in its elemental form.
Alternative 56. The method of Alternative 1 or any of the preceding alternatives, wherein the combining is a dry solid-state mixing that produces no wastewater.
Alternative 57. The method of Alternative 1 or any of the preceding alternatives, wherein the one or more elemental or compounds of Ni, the one or more elemental or compounds of Mn, the one or more elemental or compounds of Co, the one or more elemental or compounds of Al, and/or the one or more elemental or compounds of a metal dopant is a class 2 feedstock.
Alternative 58. The method of Alternative 1 or any of the preceding alternatives, wherein the one or more elemental or compounds of Ni, the one or more elemental or compounds of Mn, the one or more elemental or compounds of Co, the one or more elemental or compounds of Al, and/or the one or more elemental or compounds of a metal dopant is a class 2 non-soluble feedstock.
Alternative 59. The method of Alternative 1 or any of the preceding alternatives, wherein the one or more elemental or compounds of Ni, the one or more elemental or compounds of Mn, the one or more elemental or compounds of Co, the one or more elemental or compounds of Al, and/or the one or more elemental or compounds of a metal dopant are included as raw materials.
Alternative 60. The method of Alternative 1 or any of the preceding alternatives, wherein the one or more elemental or compounds of Ni, the one or more elemental or compounds of Mn, the one or more elemental or compounds of Co, the one or more elemental or compounds of Al, and/or the one or more elemental or compounds of a metal dopant are included in powder form.
Alternative 61. The method of Alternative 1 or any of the preceding alternatives, wherein the one or more elemental or compounds of Ni, the one or more elemental or compounds of Mn, the one or more elemental or compounds of Co, the one or more elemental or compounds of Al, and/or the one or more elemental or compounds of a metal dopant are included in powder form with a D50 less than 1,000 microns.
Alternative 62. The method of Alternative 1 or any of the preceding alternatives, wherein the one or more elemental or compounds of Ni, the one or more elemental or compounds of Mn, the one or more elemental or compounds of Co, the one or more elemental or compounds of Al, and/or the one or more elemental or compounds of a metal dopant are included in powder form with a D50 less than 500 microns.
Alternative 63. The method of Alternative 1 or any of the preceding alternatives, wherein the lithium transition metal oxide positive electrode material is free of solvent residue.
Alternative 64. The method of Alternative 1 or any of the preceding alternatives, wherein metals in the precursor mixture are in elemental form except for Li.
Alternative 65. The method of Alternative 1 or any of the preceding alternatives, additionally comprising pulverizing the heated precursor mixture through at least one of impact milling, jet milling, or grinding.
Alternative 66. A secondary battery comprising an electrode material comprising: a lithium transition metal oxide product from the method of Alternative 1.
Alternative 67. The secondary battery of Alternative 66, wherein the secondary battery is a lithium ion battery.
Alternative 68. The secondary battery of any one of Alternatives 66-67, wherein the secondary battery has a carbon-based anode.
Alternative 69. The secondary battery of any one of Alternatives 66-68, wherein the secondary battery has an anode comprised of synthetic graphite having a particle size D50 of 5 to 30 μm.
Alternative 70. The secondary battery of any one of Alternatives 66-69, wherein the secondary battery has an anode comprised of secondary particles agglomerated from primary particles having a particle size D50 of 1 to 15 μm, wherein the secondary particles have a particle size D50 of 5 to 30 μm.
Alternative 71. The secondary battery of any one of Alternatives 66-70, wherein the secondary battery has an anode material comprised of synthetic graphite and hard carbons, wherein the hard carbon content is between about 0.25 wt % and 5 wt % of the anode material.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein, but are to be accorded the widest scope consistent with this disclosure, the principles and the novel features disclosed herein.

1. A solid-state method of preparing a single crystal lithium transition metal oxide positive electrode material for a secondary battery having an empirical formula (1): 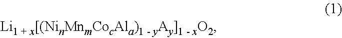
wherein: −0.2≤x≤0.2;
n+m+c+a=1;
n≥0;
m≥0;
c≥0;
a≥0;
A is a metal dopant; and
$$0 \leq y \leq 0 \text{.05} ;$$
the method comprising:
(A) preparing a mixture by combining together in the absence of water a stoichiometric amount of a Ni source, a Mn source, a Co source, an Al source, a dopant source, and/or one or more lithium compounds according to the formula (1) wherein:
at least one of the Ni source, the Mn source, the Co source, and the Al source is in the elemental form;
at least one of the Ni source, the Mn source, the Co source, and the Al source is in the form of a metal oxide;
the remaining Ni source, the Mn source, the Co source, or the Al source are metal compounds selected from the group consisting of oxides, hydroxides, oxyhydroxides, carbonates, sulfates, nitrates, acetates, and combinations thereof;
the one or more Li compounds is selected from the group consisting of Li carbonate, Li oxide, Li hydroxide, Li hydroxide monohydrate, Li acetate, Li chloride, Li fluoride, Li nitrate, Li sulfate, and mixtures thereof; and
(B) heating the mixture to produce the lithium transition metal oxide positive electrode material having a single-phase structure.

2. The method of claim 1, wherein preparing the mixture in (A) comprises dry mixing using a ball mill, an autogrinder, an impact mill, a high-speed mixer, trituration, an acoustic mixer, mechanofusion, or a blender.

3. The method of claim 1, wherein preparing the mixture in (A) is two steps in which a first mixing step is performed without the one or more Li compounds and the one or more Li compounds is added in a second mixing step.

4. The method of claim 1, wherein the Ni source, the Mn source, and the Co source are in elemental form.

5. The method of claim 1, wherein A is selected from the group consisting of: Na, B, Mg, Zr, Nb, Fe, Si, P, Mo, Ba, Sr, Ca, Zn, Cr, V, W, Nd, La, Cs, Ta, Ce, Cu, Eu, Ti, Sn, Sb, Pb, Bi, Rb, and mixtures thereof.

6. The method of claim 1, wherein:
the Ni source contains no metal element other than Ni;
the Mn source contains no metal element other than Mn;
the Co source contains no metal element other than Co; and
the Al source contains no metal element other than Al.

7. The method of claim 1, wherein y is zero.

8. The method of claim 5, wherein n is zero.

9. The method of claim 5, wherein m is zero.

10. The method of claim 5, wherein c is zero.

11. The method of claim 5, wherein a is zero.

12. The method of claim 1, wherein y is not zero and at least one of n, m, c, a is zero.

13. The method of claim 1, wherein the single crystal lithium transition metal oxide is LiNi_{0.6}Mn_{0.2}Co_{0.2}O₂.

14. The method of claim 1, wherein the single crystal lithium transition metal oxide is LiNi_{0.8}Mn_{0.1}Co_{0.1}O₂.

15. The method of claim 1, wherein heating the mixture is carried out under an atmosphere of inert gas, oxygen, a reduced oxygen partial pressure gas, dry air, or air.

16. The method of claim 15, wherein the heating is in a range between about 450-1000° C. and carried out with one or multiple temperature holds.

17. The method of claim 15, wherein the total heating time is in a range between about 10-100 hours.

18. The method of claim 1, wherein the one or more lithium compounds is added in excess of the stoichiometric amount by not greater than 20%.

19. The method of claim 18, wherein lithiation is done in one step.

20. The method of claim 18, wherein lithiation is done in two steps where a first lithiation step is carried out with −0.2≤x<0 and a second lithiation step is carried out with the remaining stoichiometric quantity of Li where a total x≤0.20.

21. The method of claim 1, wherein a post-modification is done on the single crystal lithium transition metal oxide by additionally re-heating under an atmosphere of inert gas, oxygen, a reduced oxygen partial pressure gas, dry air, or air.

22. The method of claim 21, wherein the reheating temperature is greater than 500° C. for greater than 1 hour.

23. The method of claim 1, wherein the percentage of cation mixing, the amount of Ni in the Li layers, in the single crystal lithium transition metal oxide product is lower than 6.0 mol %.

24. The method of claim 1, wherein the combining of the mixture comprises mixing the mixture in the absence of a solvent.

25. The method of claim 1, additionally comprising pulverizing the heated mixture through at least one of impact milling, jet milling, or grinding.

26. A secondary Li-ion battery comprising an electrode material comprising: a single crystal lithium transition metal oxide product from the method of claim 1.
